(19) United States
(12) Patent Application Publication
(10) Pub. No.: US 2025/0130072 A1
(43) Pub. Date: Apr. 24, 2025

(54) METHOD FOR ALIGNING AN INERTIAL NAVIGATION SYSTEM

(71) Applicant: SBG SYSTEMS, Carrières-sur-Seine (FR)

(72) Inventors: Pierre BENET, La Ferté-Bernard (FR); Mourad SAIDANI, Cergy (FR); Alexis GUINAMARD, Chatou (FR)

(21) Appl. No.: 18/924,698

(22) Filed: Oct. 23, 2024

(30) Foreign Application Priority Data
Oct. 23, 2023 (EP) 23205270.4

(51) Int. Cl. G01C 25/00

(52) U.S. Cl. CPC G01C 25/005

(57) ABSTRACT

A method for aligning an inertial navigation system, comprising the following steps: (E1, E2) Reception of first position data and second movement data; (E3) Generation of an “a priori” set of alignment initialization parameters; (E4) Correction of the “a priori” set to obtain an optimal set by the following sub-steps: (E41) Estimation of third position data from the first and second data and a corrected set of initialization parameters; (E42) Calculation of correction values of the set which minimize an error function determined from the first and second data; (E425) Correction of the set using the correction values; the first corrected set being determined from the “a priori” set and the correction step being iterated until a stopping condition is satisfied and/or a predetermined number of iterations is reached.

### CROSS-REFERENCE TO RELATED APPLICATIONS

This application claims priority pursuant to 35 U.S.C. 119 (a) to European Application No. 23205270.4, filed Oct. 23, 2023, which application is incorporated herein by reference in its entirety.

### FIELD OF THE INVENTION

The invention relates to the field of inertial navigation systems. More specifically, the invention relates to a method for aligning an inertial navigation system on board a mobile device.

### BACKGROUND

An inertial navigation system, or INS, comprises an inertial unit equipped with accelerometers and gyro meters, whose measurements can be integrated to calculate the position, velocity and orientation of the inertial unit and, as a result, of the device wherein the system is incorporated. In order to be able to estimate this data reliably, the system needs to know certain initial parameters of the inertial unit, such as its initial velocity and orientation.

At the start of navigation, the inertial navigation system must implement an initialization method called “alignment” to determine these initial parameters. Velocity and position can be easily determined for example using position data such as GNSS (Global Navigation Satellite System). However, the alignment method may need to exploit position data acquired in complicated scenarios, the data resulting from these scenarios possibly being sparse, incomplete or inaccurate.

Moreover, orientation is more difficult to initialize. Several methods for initializing this attitude are available in the literature.

“Trajectory alignment” methods require the device carrying the system to follow a straight trajectory at high velocity, with no lateral velocity. This assumption works when this device is a car, but often fails for a plane or boat, given the wind or current, or even for a pedestrian with a swaying or wobbling gait. “Magnetic alignment” methods use a magnetic compass to provide

initial orientation. However, this method can fail when metal objects are in the system environment.

A gyrocompass can be used to deduce the initial orientation, but this greatly increases the cost of the system.

“Dual antenna alignment” methods involve installing two antennas on the device carrying the system, which must be sufficiently far apart. This complicates the configuration and increases the system's size, which can make it incompatible with lightweight devices, particularly those intended for pedestrians.

None of these methods, therefore, eliminates the need for a priori knowledge of the type of system carrier, and thus guarantees that the initial parameters of the inertial navigation system can be correctly estimated, whatever the type of carrier.

The present invention is thus placed in this context and aims to meet this need.

### BRIEF SUMMARY OF THE INVENTION

To these ends, the invention has as its object a method for aligning an inertial navigation system on board a mobile device, the system comprising at least one inertial unit and a geolocation device, wherein it comprises the following steps:
a. Receiving a first set of mobile device position data acquired by the geolocation device over a given period of time;
b. Receiving a second set of movement data from the mobile device during said period of time;
c. Generating an “a priori” set of initialization parameters for inertial navigation system alignment; and,
d. Correcting the “a priori” set of initialization parameters to obtain an optimum set of initialization parameters, said correction step comprising the following sub-steps:
i. Estimating a third set of position data of the mobile device over said given period of time, the first datum of the third set of position data being estimated from the first set of position data; and each subsequent datum of the third set being estimated from at least one datum of the second set of movement data and a corrected set of initialization parameters;
ii. Calculating correction values for the initialization parameter set that minimize a given error function determined from the first position data set and the third position data set; and,
iii. Correcting the corrected set of initialization parameters using correction values;

the first corrected set being determined from the “a priori” set of initialization parameters, and said correction step being iterated until a predetermined stopping condition dependent on the correction values is satisfied and/or a predetermined number of iterations is reached, the last corrected set forming the optimal set of initialization parameters.

According to the invention, position data are acquired during a period wherein the mobile device, or carrier, incorporating the navigation system has moved. This position data could be, for example, GNSS-type data including coordinates in a three-axis coordinate system, or alternatively another type of geolocation data. In view of the carrier's displacement, the inertial measurement system also acquires movement data over the same period of time. Typically, this data can comprise a measurement of the carrier's acceleration along each of the three axes of the coordinate system and a measurement of the carrier's angular velocity along each of these three axes.

By integrating these movement data through the inertial unit's

mechanization equations and using one of the position data, it is possible to estimate a blind trajectory for the carrier. This trajectory depends substantially on the set of initialization parameters of the inertial unit that the invention seeks to estimate, so that it is possible to define an error function between this estimated trajectory and the trajectory translated by the position data, this function thus depending on this set of initialization parameters.

The invention thus proposes to generate a set of “a priori” initial parameters, which can be determined arbitrarily or based on known information on the inertial unit sensors or on the carrier itself. This “a priori” set of parameters is then corrected iteratively, using a non-linear least squares method. According to this method, at each iteration, the values of the current initial parameter set are fed back into the inertial unit's mechanization equations to redetermine a blind trajectory for the carrier, as well as the error between the actual trajectory translated by the position data and this blind trajectory. A correction value for each initial parameter is determined by minimizing this error function, using a linear least-squares method, and the current values of the initial parameter set are corrected using these correction values so that a new iteration can be carried out. These iterations continue until a given number of iterations has been reached, or a stopping condition has been met, allowing the algorithm to be considered to have converged to an optimal set. The invention therefore makes it possible to obtain an optimal set of initial parameters in a short time, whatever the type of carrier.

In the invention, “position data” refers to data acquired by a geolocation device, indicating the carrier's position in a given coordinate system. These may be GNSS-type data, such as GPS or Galileo, received by a receiver on board the carrier, including coordinates along three axes of said coordinate system. The data may also be identification data from one or more telecommunication antennas, in particular of the GSM, WiFi or RFID type, located in the vicinity of the carrier, the geolocation device then comprising a calculation unit for determining the carrier's position based on said received data.

In the invention, “movement data” refers to data relating to the carrier's movement in a given coordinate system, estimated by the sensors of an inertial unit. The inertial unit could, for example, be a 6-axis unit, comprising three accelerometers, each able to measure the acceleration of the carrier along one of the axes of the given coordinate system, and three gyro meters, each able to measure the angular velocity of the carrier along one of the axes of the given coordinate system. Preferably, the coordinate system for position data will be identical to that for movement data.

Preferably, in the invention, the generation and correction steps will

only be implemented on the condition that the first set of position data and/or the second set of movement data indicates a displacement of the mobile device during said period of time.

Still preferably, each position datum in the first set comprises time information, and the step of calculating correction values employs only those data in the third set of position data that have been estimated for times corresponding to said time information in the data in the first set.

In one embodiment of the invention, for each estimating sub-step, the first datum of the third position data set is estimated from the last datum of the first position data set. If necessary, each subsequent datum in the third position data set is recursively estimated from the previously estimated datum in the third position data set and the datum in the second position data set preceding that used to estimate the previously estimated datum in the third position data set. In other words, according to this feature, the last position datum acquired by the geolocation device is used to initialize the calculation of the carrier's blind trajectory, and this trajectory is estimated backwards from this last position datum. Owing to this feature, the optimal set of initialization parameters obtained as a result of the method according to the invention is up to date, with regard to the carrier's position, and can therefore be used as it stands by the inertial navigation system, in particular by a Kalman filter.

In one embodiment of the invention, each datum in the second set of movement data comprises an acceleration of the inertial unit and an angular velocity of the inertial unit, and the set of initialization parameters comprises an initial orientation of the inertial unit and an initial velocity of the inertial unit. If applicable, in each sub-step of estimating the third data set of each iteration of the correction step, the estimation of each following datum comprises:
a. estimating an orientation for the inertial unit from the previously estimated orientation and the angular velocity of a datum in the second set;
b. estimating a velocity for the inertial unit from the previously estimated velocity, the previously estimated orientation and the acceleration of a datum from the second set; and,
c. estimating a position for the inertial unit from the previously estimated position and the previously estimated velocity.

In other words, according to this feature, the “a priori” initialization parameter set comprises an “a priori” initial orientation, for example in the form of a triplet of orientations along each of the axes of the coordinate system, and an “a priori” initial velocity, for example in the form of a triplet of velocities along each of the axes of the coordinate system. At each new iteration, a new orientation can thus be determined from the orientation determined in the previous iteration, and a new velocity and position can be estimated from this new orientation in order to reconstruct a blind trajectory.

For example, the orientations, velocities and positions of the third data set can be recursively estimated, at each iteration of the correction step, using the following equations:

$${R}_{t , i} = {R}_{t , i - 1} . {e}^{{w}_{t} . Δ t} {v}_{t , i} = {v}_{t , i} + ( {R}_{t , i} . {a}_{t} + g ) . Δ t {p}_{t , i} = {p}_{t , i} + {v}_{t , i} . Δ t \qquad [ Math . 1 ]$$

where R_{t,i}, v_{t,i} and p_{t,i} are respectively an orientation, a velocity and a position of the inertial unit determined at a time t, during the i^{th} iteration, wₜ and aₜ are respectively an angular velocity and an acceleration measured by the inertial unit at a time t, g is the gravity acceleration vector and Δt is a time step used for successive estimation of orientations, velocities and positions during a single iteration of the correction step.

It is thus understood that, during the first iteration, the various orientations R_{t,1}, velocities v_{t,1} and positions p_{t,1} of the inertial unit are recursively estimated from the initial position p_{0,0}, which may in particular be the last position GNSS₀ acquired by the geolocation device, the initial “a priori” orientation R_{0,0} and the initial “a priori” velocity v_{0,0}. Each new iteration of the correction step thus corrects this initial orientation and initial velocity until an “optimal” initial orientation and an “optimal” initial velocity are reached.

According to one example, the initial velocity of the “a priori” set is set to a zero value and the initial orientation of the “a priori” set is determined beforehand from the average of gravity measurements acquired by the inertial unit during said given period of time. These gravity measurements make it possible to obtain, prior to the iterations of the correction step, a rough measurement of the pitch and roll of the inertial unit, and thus to accelerate the convergence of the non-linear least-squares method toward optimal values of initial velocity and initial orientation. Alternatively, the initial orientation of the set can be an identity matrix.

Advantageously, the initial orientation of the inertial unit is defined by both an initial angular correction and an initial rotation matrix. If required, the initial angular correction can be reset to zero at each iteration of the correction step, the initial rotation matrix can be determined at each iteration of the correction step from the previous initial rotation matrix and the initial angular correction, and each estimate of an orientation of the inertial unit can be an estimate of the rotation matrix of the inertial unit from the previously estimated rotation matrix and the angular velocity of a datum of the second set.

According to this feature, the initial orientation of the inertial unit is defined, at each iteration, only by the initial rotation matrix. This rotation matrix is thus corrected by the orientation correction value obtained at the end of the correction step, and this correction value is then reset. This avoids a gimbal lock problem.

In one embodiment of the invention, the initialization parameter set comprises a bias of an accelerometer of the inertial unit and a bias of a gyro meter of the inertial unit. If applicable, in each sub-step of estimating the third data set of each iteration of the correction step, the estimation of each following datum comprises:
a. estimating an orientation for the inertial unit from the previously estimated orientation, the angular velocity of a datum in the second set and the bias of the gyro meter;
b. estimating a velocity for the inertial unit from the previously estimated velocity, the previously estimated orientation, the acceleration of a datum from the second set and the bias of the accelerometer;
c. estimating a position for the inertial unit from the previously estimated position and the previously estimated velocity.

In other words, according to this feature, the “a priori” initialization parameter set can comprise, in addition to the “a priori” initial orientation and the “a priori” initial velocity, an “a priori” initial gyro meter bias and an “a priori” initial accelerometer bias. These initial “a priori” biases could, for example, be set to zero. More generally, the set of “a priori” initialization parameters may comprise other biases or errors in the inertial unit sensors, or more generally in the inertial navigation system, such as scaling factors or lever arms.

For example, the orientations, velocities and positions of the third data set can be recursively estimated, at each iteration of the correction step, using the following equations:

$${R}_{t , i} = {R}_{t , i - 1} . {e}^{( {w}_{t} - {b}_{g , i} ) . Δ t} {v}_{t , i} = {v}_{t , i} + ( {R}_{t , i} . ( {a}_{t} - {b}_{a , i} ) + g ) . Δ t {p}_{t , i} = {p}_{t , i} + {v}_{t , i} . Δ t \qquad [ Math . 2 ]$$

where R_{t,i}, v_{t,i} and p_{t,i} are respectively an orientation, velocity and position of the inertial unit determined at an instant t, during the iₜₕ iteration, b_{g,i} and b_{a,i} are respectively an initial bias of the accelerometers of the inertial unit and an initial bias of the gyro meters of the inertial unit determined during the iₜₕ iteration, wₜ and aₜ are respectively an angular velocity and an acceleration measured by the inertial unit at an instant t, g is the gravity acceleration vector and Δt is a time step used for successive estimation of orientations, velocities and positions during a single iteration of the correction step.

According to one example embodiment, each of these initial “a priori” biases can be set to a zero value.

In one embodiment of the invention, said given error function is determined from a comparative function corresponding to the difference between the position data of the first position data set and the third position data set, said comparative function being calculated at each iteration of the correction step. According to this feature, the comparative function can thus be formed by a vector, each element of which corresponds to the difference between a datum in the third set and a corresponding datum in the first set, that is, a datum whose time of acquisition by the geolocation device corresponds to the time at which the datum in the third set was estimated. The error function can thus be a cost function expressing a distance from this comparative function, which the iterations of the correction step aim to minimize.

Advantageously, for each iteration of the correction step, the sub-step for calculating the correction values of the initialization parameter set involves determining the covariance of said comparative function, said correction values being calculated from said covariance. In this example, the comparative function can be based on a Mahalanobis distance of the comparative function, which takes into account the covariance of the comparative function and is particularly suitable for the data employed by the invention.

Still advantageously, for each iteration of the correction step, the sub-step for calculating the correction values of the initialization parameter set involves determining the covariance of said comparative function and the gradient of the comparative function, said correction values being calculated from said covariance and said gradient. These iterations then implement a Gauss-Newton-type algorithm, which involves a gradient of the comparative function, in the form of a Jacobian of this function, in the calculation of the error function, referred to in this context as a “residual.” Each iteration of the correction function thus determines, from the covariance and gradient of the comparative function, correction values for the initial parameters determined in the previous iteration, which minimize this residual.

For each iteration, these correction values can in particular be obtained using the following equation:

$$Δ x = - {( {( \frac{\partial f ( x )}{\partial x} )}^{T} . {G}^{- 1} . \frac{\partial f ( x )}{\partial x} )}^{- 1} . ( {( \frac{\partial f ( x )}{\partial x} )}^{T} . {G}^{- 1} . f ( x ) ) \qquad [ Math . 3 ]$$

where Δx are the correction values, x is the set of initialization parameters determined in the previous iteration, f(x) is the comparative function obtained for this set x, and G is the covariance matrix of the comparative function.

Advantageously, said gradient of the comparative function is estimated by an approximation using a centered difference operator. In fact, the Jacobian of the comparative function can be complex to determine, and thus requires additional computation time. This feature makes it possible to approximate the gradient with a limited number of additional evaluations of the comparative function.

In one embodiment of the invention, said given error function, used to implement each step of calculating correction values, may be determined from the first set of position data, the third set of position data and additional information about the inertial navigation system. This additional information, which may be information on the inertial unit sensors or on the type of carrier, makes it possible to introduce regularization at each iteration of the step for calculating the correction value, and thus to improve the convergence of the algorithm toward the optimal initial parameter set.

Advantageously, for each iteration of the correction step, the sub-step for calculating the correction values of the initialization parameter set comprises a regularization using predetermined values of the covariances of the initialization parameters. In other words, the iterations of the correction step aim to minimize both a given distance of the comparative function and a given distance of the initial parameters themselves, which makes it possible to introduce previously known statistical values of these initial parameters and thus further accelerate the convergence of the algorithm.

Preferably, for each iteration, the correction values can in particular be obtained using the following equation:

$$Δ x = - {( {( \frac{\partial f ( x )}{\partial x} )}^{T} . {G}^{- 1} . \frac{\partial f ( x )}{\partial x} + {P}_{i n}^{- 1} )}^{- 1} . ( {( \frac{\partial f ( x )}{\partial x} )}^{T} . {G}^{- 1} . f ( x ) + {P}_{i n}^{- 1} . x ) \qquad [ Math . 4 ]$$

where Δx are the correction values, x is the set of initialization parameters determined in the previous iteration, f(x) is the comparative function obtained for this set x, G is the covariance matrix of the comparative function, and Pᵢₙ is the covariance matrix of the initialization parameters.

In this example, the covariance of two distinct initial parameters can be considered as zero, the covariance matrix of the initial parameters then being a diagonal matrix, composed of the standard deviations of the initial parameters. The standard deviations of the initial biases of the sensors are predetermined and are usually given in the specifications of these sensors. The standard deviations of the initial orientation and velocity can be estimated based on the type of carrier. In particular, the standard deviation of the initial velocity can be set at the maximum velocity the carrier can travel, e.g., 3 m/s for a pedestrian or 100 m/s for a car.

In one embodiment of the invention, said predetermined stop condition depending on the correction values corresponds to a comparison of said correction values with predetermined threshold values, said stop condition being satisfied when said correction values are lower than said predetermined threshold values.

Preferably, in the event that the predetermined number of iterations is reached without said stopping condition being satisfied, the parameter values of the last corrected set can be rejected and a new iteration of the method can optionally be implemented.

Alternatively, or cumulatively, the method may comprise a step for determining the covariance of the parameters of the optimal set of initialization parameters, and a step for comparing, directly or indirectly, these covariances with given threshold values, the values of the parameters of the optimal set being rejected based on said comparison. This feature makes it possible to rule out parameters that would be outliers, particularly with regard to the “a priori” covariance of these parameters.

For example, in the case where said parameters are formed by triplets, a value of a norm of the covariance of each parameter of the optimal set can be determined and said value compared with a given threshold value, optionally determined from the standard deviation of said initial parameter, said parameter of the optimal set being rejected if said norm is greater than said given threshold value.

In one embodiment of the invention, the method comprises the following later steps:
a. Determining the covariance of the parameters in the optimal set of initialization parameters;
b. Providing the parameters of the optimal set of initialization parameters and their covariance to a calculation unit of the inertial navigation system as arguments of an Extended Kalman filter.

The invention also relates to an inertial navigation system on board a mobile device, the system comprising at least one inertial unit, a geolocation device and a calculation unit arranged to implement the method according to the invention.

The invention also relates to a computer program comprising program code which is designed to implement the method according to the invention.

The invention also relates to a data carrier on which the computer program according to the invention is recorded.

### BRIEF DESCRIPTION OF THE DRAWINGS

The present invention is now described with the aid of examples that are purely illustrative and in no way limiting on the scope of the claims, and based on the attached drawings, in which the various figures show:

FIG. 1 shows, schematically and partially, a method for aligning an inertial navigation system on board a mobile device according to one embodiment of the invention;

FIG. 2 shows, schematically and partially, first and second sets of data relating to the movement of the mobile device during the implementation of the method of FIG. 1;

FIG. 3A shows, schematically and partially, a blindly estimated trajectory of the mobile device during a first iteration of the method shown in FIG. 1;

FIG. 3B shows, schematically and partially, a blindly estimated trajectory of the mobile device during a later iteration of the method shown in FIG. 1; and,

FIG. 3C shows, schematically and partially, a blindly estimated trajectory of the mobile device during the final iteration of the method shown in FIG. 1.

### DETAILED DESCRIPTION OF THE INVENTION

In the following description, identical elements, by structure or function, appearing in different figures retain, unless otherwise specified, the same references. Of course, various other modifications can be made to the invention within the scope of the appended claims.

FIG. 1 shows a method for aligning an inertial navigation system on board a mobile device, or carrier.

In the embodiment to be disclosed, the system comprises at least one inertial unit and a geolocation device on board the carrier.

In a first step E1, the geolocation device receives a first set GNSS comprising a number n of position data GNSSᵢ for the carrier as the carrier moves along a trajectory T for a given period of time. In the example disclosed, each position datum GNSSᵢ comprises coordinates in a three-axis coordinate system defining the position of the geolocation device in this coordinate system at an instant tᵢ, as well as this instant tᵢ.

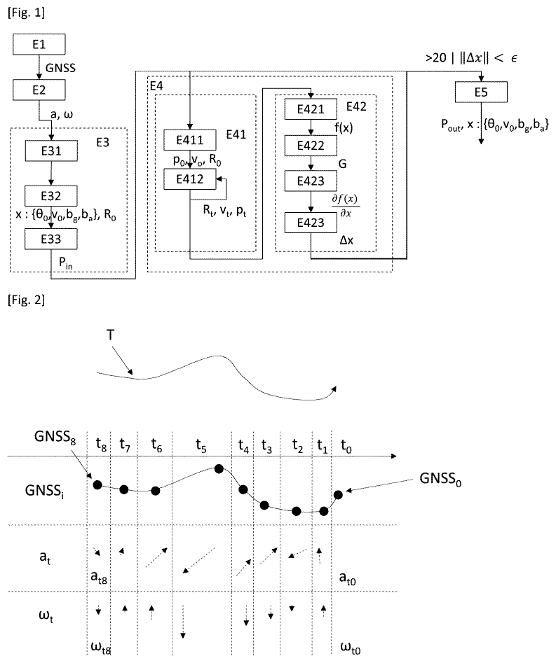

For simplification purposes, FIG. 2 shows the trajectory T and these data GNSS in a two-axis coordinate system, with the set GNSS comprising 9 data points GNSS₀ to GNSS₈, each corresponding to an instant t₀ to t₈, these instants being decreasing.

In a second step E2, simultaneously with the first step E1, the inertial unit acquires a second set of data (a,ω) on the carrier's movement acquired during the carrier's displacement along the trajectory T. In the example disclosed, the inertial unit is a 6-axis unit, comprising three accelerometers, each able to measure an acceleration of the carrier along one of the axes of the given coordinate system, and three gyro meters, each able to measure an angular velocity of the carrier along one of the axes of the given coordinate system. Each movement datum thus comprises an acceleration aₜ and an angular velocity ωₜ of the inertial unit at an instant t.

The data aₜ and ωₜ were also plotted in FIG. 2, as a two-dimensional vector. For simplicity's sake, it is assumed in the example disclosed that the coordinate system of the position data is identical to that of the movement data, it being understood that, should these coordinate systems be distinct, a change of coordinate system would enable switching from one to the other. Furthermore, only the movement data corresponding to the position data acquisition instants t₀ to t₈ are shown, with the understanding that the number of movement data may be substantially greater than the number of position data.

Once the GNNS and (a,ω) data have been acquired, in a step E3, a system calculation unit generates an “a priori” set x of parameters for initializing the alignment of the inertial navigation system.

This “a priori” initialization parameter set x comprises an initial “a priori” inertial unit orientation θ₀, an initial “a priori” inertial unit velocity v₀, an initial “a priori” gyro meter bias b_{g} and an initial “a priori” accelerometer bias bₐ.

In order to avoid a gimbal lock problem, the initial orientation of the inertial unit is defined both by an initial angular correction θ₀, in the form of a triplet of angles, and an initial rotation matrix R₀, of dimensions 3 by 3, defining the attitude of the carrier at instant t₀.

In a sub-step E31, the calculation unit can average gravity measurements acquired by the inertial unit as the carrier moves along the trajectory T, in order to estimate first values for the initial pitch and roll of the inertial unit.

In a sub-step E32, the calculation unit thus defines the initial rotation matrix R₀ such that it aligns the average acceleration measured by the accelerometer with gravity, that is, R₀=e^{θg}, where one of the elements of θg corresponds to this initial pitch, another of the elements corresponds to this initial roll and the last element is set to a zero value. Alternatively, the initial rotation matrix R₀ can be an identity matrix. The initial angular correction θ₀ is set to zero.

Also in sub-step E32, the “a priori” initial velocity v₀ is set, in the form of a triplet of velocities along each of the coordinate system axes, to a zero value, and the “a priori” initial biases bₐ and b_{g} are also set, in the form of two triplets, to zero values.

Finally, in a sub-step E33, a covariance matrix Pᵢₙ of these initial parameters θ₀, v₀, b_{g} and bₐ is estimated by the calculation unit.

The matrix Pᵢₙ could, for example, be a diagonal matrix, wherein the first triplet of elements of the diagonal, corresponding to the covariance of the initial orientation, is set to a value of π squared, the second triplet of elements of the diagonal, corresponding to the covariance of the initial velocity, is set to the maximum velocity that the carrier can travel squared, the third triplet of diagonal elements, corresponding to the covariance of the gyro meter bias, is set to the standard deviation of the gyro meter bias squared, and the fourth triplet of diagonal elements, corresponding to the covariance of the accelerometer bias, is set to the standard deviation of the accelerometer bias squared.

This matrix Pᵢₙ is used to introduce a regularization into the algorithm that will be described later, in order to introduce known elements into the calculation of the optimal values of the initial parameters and speed up the convergence of the algorithm. The values given above can be replaced by any more precise value resulting from “a priori” knowledge of these initial parameters.

The calculation unit then performs a first iteration of a correction step E4 of the “a priori” set x.

To this end, in a first sub-step E41, the calculation unit determines a third set of position data pₜ of the carrier as it moves along the trajectory T, from the data sets GNNS and (a,ω).

More precisely, in a sub-step E411, the calculation unit sets an initial position of the carrier p₀ to the coordinates contained in the latest datum GNSS₀ of the first set GNSS, that is, whose instant to is the most recent. The initial orientation is set to e^{θ}^{ₒ}. R₀ and the initial velocity is set to v₀. It is therefore understood that the set of initialization parameters, which the calculation unit seeks to determine, corresponds to the orientation and velocity of the inertial unit and the sensor biases at instant t₀, when the carrier was in its last position GNSS₀.

Each subsequent position pₜ is then recursively estimated, in a sub-step E412, from the previously estimated data pₜ₋₁, the biases bₐ and b_{g} and the data (a,ω).

In the example disclosed, the calculation unit thus estimates a plurality of orientations Rₜ of the inertial unit, each calculated from the previously calculated orientation Rₜ₋₁, the angular velocity ωₜ and the gyro meter bias b_{g}, for example by means of the following equation:

$${R}_{t} = {R}_{t - 1} . {e}^{( {w}_{t} - {b}_{g} ) . Δ t} . \qquad [ Math . 5 ]$$

The calculation unit then estimates a plurality of velocities vₜ of the inertial unit, each calculated from the previously calculated velocity vₜ₋₁, the orientation Rₜ estimated in the previous calculation, the acceleration at and the bias of the accelerometer bₐ, for example by means of the following equation:

$${v}_{t} = {v}_{t - 1} + ( {R}_{t} . ( {a}_{t} - {b}_{a} ) + g ) . Δ t . \qquad [ Math . 6 ]$$

Finally, the calculation unit estimates a plurality of positions pₜ of the inertial unit, each calculated from the previously calculated position pₜ₋₁ and the velocity vₜ estimated in the previous calculation, for example by means of the following equation:

$${p}_{t} = {p}_{t - 1} + {v}_{t} . Δ t . \qquad [ Math . 7 ]$$

In this example, the step Δt corresponds to the offset between two successive data acquisition instants (a,ω).

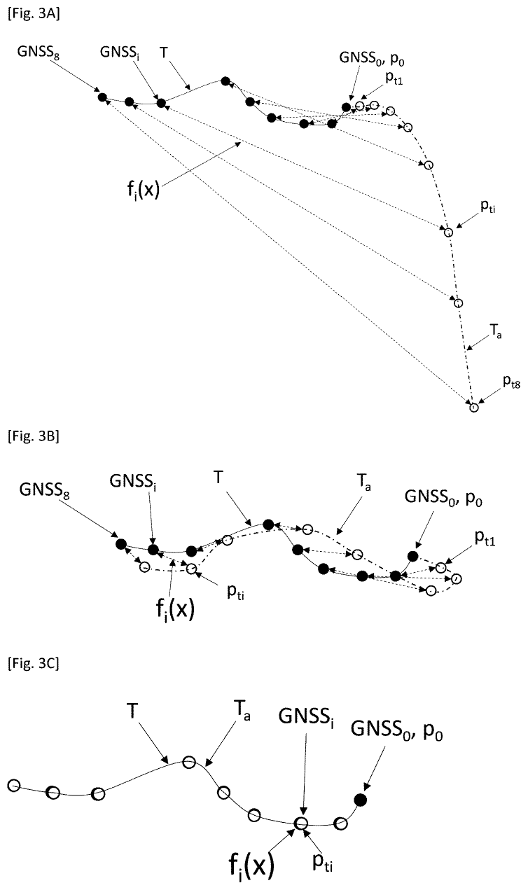

FIG. 3A shows the positions pₜ obtained by the calculation unit at the end of this first iteration, forming a “blind” trajectory Tₐ.

This means that, during the first iteration, the various orientations Rₜ, velocities vₜ and positions pₜ of the inertial unit are estimated recursively and backwards from the last position GNSS₀ known to the carrier and the “a priori” initialization parameter set x. The resulting data pₜ therefore depend on the values of the set x.

In a second sub-step E42, the calculation unit then determines correction values Δx of the “a priori” initialization parameter set x, enabling minimization of an error function, or cost function, on a comparative function f(x) between position data GNSS and position data pₜ obtained from the “a priori” initialization parameter set x.

To this end, in a sub-step E421, the calculation unit estimates the comparative function f(x). In the example described, this comparative function f(x) is a vector, each element fᵢ(x) of which corresponds to the difference between the position of a datum GNSSᵢ at instant tᵢ and the position pₜ_{ᵢ}; obtained for the same instant tᵢ.

These elements fᵢ(x) have been plotted in FIG. 3A, with the understanding that the element f₀(x) is by construction zero and is therefore omitted in the following steps.

It is thus possible to express a distance from this comparative function, which is also based on x and adopts a minimum at which the “blind” trajectory Tₐ approaches the trajectory T.

The subsequent steps of sub-step E42 which will now be disclosed depend on the type of distance to be minimized, it being understood that other distances can be envisaged without departing from the scope of the present invention. In a sub-step E422, the calculation unit estimates a covariance G of the comparative function f(x), for example by approximating it using the following equation:

$$G = \frac{{‖ f ( x ) ‖}^{2}}{n} . \qquad [ Math . 8 ]$$

In a sub-step E423, the calculation unit also estimates a gradient

$$\frac{\partial f ( x )}{\partial x}$$

of the function f(x). In the example disclosed, said gradient is approximated by the calculation unit with a centered difference operator. The function f(x), and therefore the positions pₜ, are thus re-evaluated, for different elementary variations of the parameters θ₀, v₀, b_{g} and bₐ around their values.

In a sub-step E424, the calculation unit determines correction values Δx, using the covariance G, the gradient

$$\frac{\partial f ( x )}{\partial x} ,$$

the covariance matrix Pᵢₙ, the comparative function f(x) and the values of the parameters of the set x. These correction values Δx, when applied to the values of the parameters of the set x, minimize both a Mahalanobis distance of the comparative function f(x) and this same distance done on the initial parameters themselves, thus regularizing the calculation.

In this example, the correction values Δx can be obtained using the following equation:

$$Δ x = - {( {( \frac{\partial f ( x )}{\partial x} )}^{T} . {G}^{- 1} . \frac{\partial f ( x )}{\partial x} + {P}_{i n}^{- 1} )}^{- 1} . ( {( \frac{\partial f ( x )}{\partial x} )}^{T} . {G}^{- 1} . f ( x ) + {P}_{i n}^{- 1} . x ) \qquad [ Math . 9 ]$$

In a sub-step E425, the rotation matrix R0 is updated, using the correction value Δθ₀ determined for the angle θ₀, and then this correction value Δθ₀ is reset to a zero value, thus preventing gimbal block. Then, the parameter values of the “a priori” set x of initialization parameters are updated with the correction values Δx, the set now being a “corrected” set.

Step E4 is then iterated, with new positions pₜ of the “blind” trajectory Tₐ being estimated from this new “corrected” set x of parameters. These new positions Pₜ make it possible to re-estimate the comparative function f(x) and therefore recalculate new correction values Δx.

The correction step is thus iterated either until a norm of the correction values Δx is less than a predetermined threshold value ε, or until a predetermined number of iterations, for example 20, is reached. In this case, the last corrected set x forms an optimal set of initialization parameters.

The iterations of correction step E4 thus implement a Gauss-Newton algorithm, which, via gradient descent, converges the set x toward optimal values for which the error function on the comparative function f(x), referred to in this context as the “residual,” is minimal.

FIG. 3B and FIG. 3C thus show the trajectory T_{A} obtained for an intermediate iteration of correction step E4 and for the last iteration of the correction step, the trajectory T_{A} then being substantially identical to the trajectory T.

In a step E5, the calculation unit can then determine the covariance Pₒᵤₜ of the parameters of the optimal set x of initialization parameters and supply the parameters θ₀, v₀, b_{g} and bₐ of the optimal set x and their covariance Pₒᵤₜ as arguments for an Extended Kalman filter.

Note that, since the optimal set x has been estimated for the last known position of the carrier, starting from the position GNSS₀, this optimal set x is up to date, and can therefore be used as is by the Kalman filter.

The preceding description clearly explains how the invention makes it possible to achieve the objectives it has set itself, namely to provide a method for aligning an inertial navigation system on board a mobile device, which makes it possible to dispense with a priori knowledge of the type of carrier of the system, and thus to guarantee that the initial parameters of the inertial navigation system can be estimated correctly, whatever the type of carrier.

In any case, the invention is not limited to the embodiments specifically described in this document, and extends in particular to any equivalent means and to any technically operative combination of these means. In particular, other error functions and distance calculations than those described above, other methods of approximating covariances and gradients than those described above, other methods of initializing parameter values than those described above, and even other types of position and/or movement data than those described above can be provided.

1. A method for aligning an inertial navigation system on board a mobile device, the system comprising at least one inertial unit and a geolocation device, wherein it comprises the following steps:
a. (E1) Receiving a first set of mobile device position data acquired by the geolocation device over a given period of time;
b. (E2) Receiving a second set of movement data from the mobile device during said period of time;
c. (E3) Generating an “a priori” set of initialization parameters for inertial navigation system alignment; and,
d. (E4) Correcting the “a priori” set of initialization parameters to obtain an optimum set of initialization parameters, said correction step comprising the following sub-steps:
i. (E41) Estimating a third set of position data of the mobile device over said given period of time, the first datum of the third set of position data being estimated from the first set of position data; and each subsequent datum of the third set being estimated from at least one datum of the second set of movement data and a corrected set of initialization parameters;
ii. (E42) Calculating correction values for the initialization parameter set that minimize a given error function determined from the first position data set and the third position data set; and,
iii. (E425) Correcting the corrected set of initialization parameters using correction values;
the first corrected set being determined from the “a priori” set of initialization parameters, and said correction step being iterated until a predetermined stopping condition dependent on the correction values is satisfied and/or a predetermined number of iterations is reached, the last corrected set forming the optimal set of initialization parameters.

2. The alignment method according to claim 1, wherein for each estimation sub-step (E41), the first datum of the third set of position data is estimated from the last datum of the first set of position data, and in that each subsequent datum of the third set of position data is recursively estimated from the previously estimated datum of the third set of position data and from the datum of the second set of position data preceding that used for estimating the datum of the third previously estimated set.

3. The alignment method according to claim 1, wherein each datum of the second set of movement data comprises an acceleration of the inertial unit and an angular velocity of the inertial unit, wherein the set of initialization parameters comprises an initial orientation of the inertial unit and an initial velocity of the inertial unit, wherein, in each estimation sub-step (E41) of each iteration of the correction step (E4), the estimation of each subsequent datum comprises:
a. estimating an orientation for the inertial unit from the previously estimated orientation and the angular velocity of a datum in the second set;
b. estimating a velocity for the inertial unit from the previously estimated velocity, the previously estimated orientation and the acceleration of a datum from the second set; and,
c. estimating a position for the inertial unit from the previously estimated position and the previously estimated velocity.

4. The method according to claim 3, wherein the initial velocity of the “a priori” set is set to a zero value and wherein the initial orientation of the “a priori” set is determined beforehand from the average of gravity measurements acquired by the inertial unit during said given period of time.

5. The method according to claim 3, wherein the initial orientation of the inertial unit is defined both by an initial angular correction and an initial rotation matrix, wherein the initial angular correction is reset to a zero value at each iteration of the correction step (E4), wherein the initial rotation matrix is determined, at each iteration of the correction step, from the previous initial rotation matrix and the initial angular correction, and wherein each estimate of an orientation of the inertial unit is an estimate of the rotation matrix of the inertial unit from the previously estimated rotation matrix and the angular velocity of a datum of the second set.

6. The alignment method according to claim 3, wherein the set of initialization parameters comprises a bias of an accelerometer of the inertial unit and a bias of a gyro meter of the inertial unit, wherein, in each estimation sub-step (E41) of each iteration of the correction step (E4), the estimation of each following datum comprises:
a. estimating an orientation for the inertial unit from the previously estimated orientation and the angular velocity of a datum in the second set and the bias of the gyro meter;
b. estimating a velocity for the inertial unit from the previously estimated velocity, the previously estimated orientation and the acceleration of a datum from the second set and the bias of the accelerometer;
c. estimating a position for the inertial unit from the previously estimated position and the previously estimated velocity.

7. The alignment method according to claim 1, wherein said given error function is determined from a comparative function corresponding to the difference between the position data of the first position data set and the third position data set, said comparative function being calculated at each iteration of the correction step (E4).

8. The alignment method according to claim 7, wherein for each iteration of the correction step (E4), the sub-step (E42) for calculating the correction values of the initialization parameter set involves determining the covariance of said comparative function, said correction values being calculated from said covariance.

9. The alignment method according to claim 8, wherein for each iteration of the correction step (E4), the sub-step (E42) for calculating the correction values of the initialization parameter set involves determining the covariance of said comparative function and the gradient of the comparative function, said correction values being calculated from said covariance and said gradient.

10. The alignment method according to claim 9, wherein said gradient of the comparative function is estimated by an approximation using a centered difference operator.

11. The alignment method according to claim 1, wherein said given error function, used to implement each step (E42) of calculating correction values, is determined from the first set of position data, the third set of position data and additional information about the inertial navigation system.

12. The alignment method according to claim 11, wherein for each iteration of the correction step (E4), the sub-step (E42) for calculating the correction values of the initialization parameter set comprises a regularization using predetermined values of the covariances of the initialization parameters.

13. The alignment method according to claim 1, wherein said predetermined stop condition depending on the correction values corresponds to a comparison of said correction values with predetermined threshold values, said stop condition being satisfied when said correction values are lower than said predetermined threshold values.

14. The alignment method according to claim 1, the method comprising the following subsequent steps:
a. (E5) Determining the covariance of the parameters in the optimal set of initialization parameters;
b. (E5) Providing the parameters of the optimal set of initialization parameters and their covariance to a calculation unit of the inertial navigation system as arguments of an Extended Kalman filter.

15. An inertial navigation system on board a mobile device, the system comprising at least one inertial unit, a geolocation device and a calculation unit arranged to implement the method according to claim 1.
